(19) United States
(12) Patent Application Publication
(10) Pub. No.: US 2013/0042173 A1
(43) Pub. Date: Feb. 14, 2013

(54) Integrated electronic compilation of study material

(71) Applicants: Babur Habib, Santa Clara, CA (US); David Straus, Los Altos, CA (US); Osman Rashid, Fremont, CA (US); Adrian Muresan, Napoca (RO); Radu Lazar, Cluj Napoca (RO); Lehel Kulscar, Ctuj Napaca (RO); Jakab Szaboles, Ctuj Napoca (RO)

(72) Inventors: Babur Habib, Santa Clara, CA (US); David Straus, Los Altos, CA (US); Osman Rashid, Fremont, CA (US); Adrian Muresan, Napoca (RO); Radu Lazar, Cluj Napoca (RO); Lehel Kulscar, Ctuj Napaca (RO); Jakab Szaboles, Ctuj Napoca (RO)

(73) Assignee: KNO, INC., Santa Clara, CA (US)

(21) Appl. No.: 13/206,470

(22) Filed: Aug. 9, 2011

(51) Int. Cl. G06F 17/24

(52) U.S. Cl. 715/255

(57) ABSTRACT

An apparatus and method to electronically compile an integrated summary document across several different educational sources is provided. The integrated summary document can contain links back to the original sources. Within the integrated summary document, searches, social learning elements and other content can also be integrated and linked to external content.

### FIELD OF THE INVENTION

The invention relates generally to electronic devices. More particularly, the invention relates to an electronic device used to consume electronic documents.

### BACKGROUND OF THE INVENTION

In the educational environment, the learning experience includes various sources of information such as lectures, class notes, textbooks, homework, study groups etc. In the educational environment, it is common for students to desire to distill a subset of information from all of the different sources of information to use as an overall summary or as an examination preparation source.

Increasingly, students are able to utilize an electronic version of each of the different sources available. For example, textbooks can be electronic, classroom notes can be taken on an electronic tablet or handwritten and then scanned, and study groups can share information online. Despite many individual sources of information being available electronically and individual documents being summarized electronically, there is still a need for an electronic integrated summary of all of the sources of information used for a particular learning experience, such as for an individual class.

### SUMMARY OF THE INVENTION

An apparatus and method to electronically compile an integrated summary document across several different educational sources is provided. The integrated summary document can contain links back to the original sources. Within the integrated summary document, searches, social learning elements and other content can also be integrated and linked to external content.

### BRIEF DESCRIPTION OF THE DRAWINGS

FIG. 1 displays a portion of an integrated summary document.

FIG. 2 displays a portion of an integrated summary document including content added from a class help session.

FIG. 3 displays a portion of an integrated summary document including links to relevant social media.

### DETAILED DESCRIPTION OF THE DRAWINGS

This invention helps meet the described need by providing a way to integrate and summarize many different sources of information with a common theme.

In the educational environment, it is common for classes to utilize many different sources of information. For example, in addition to traditional mediums such as textbooks and classroom lectures, students now learn through social learning elements, shared notes, searching on the web for related material etc.

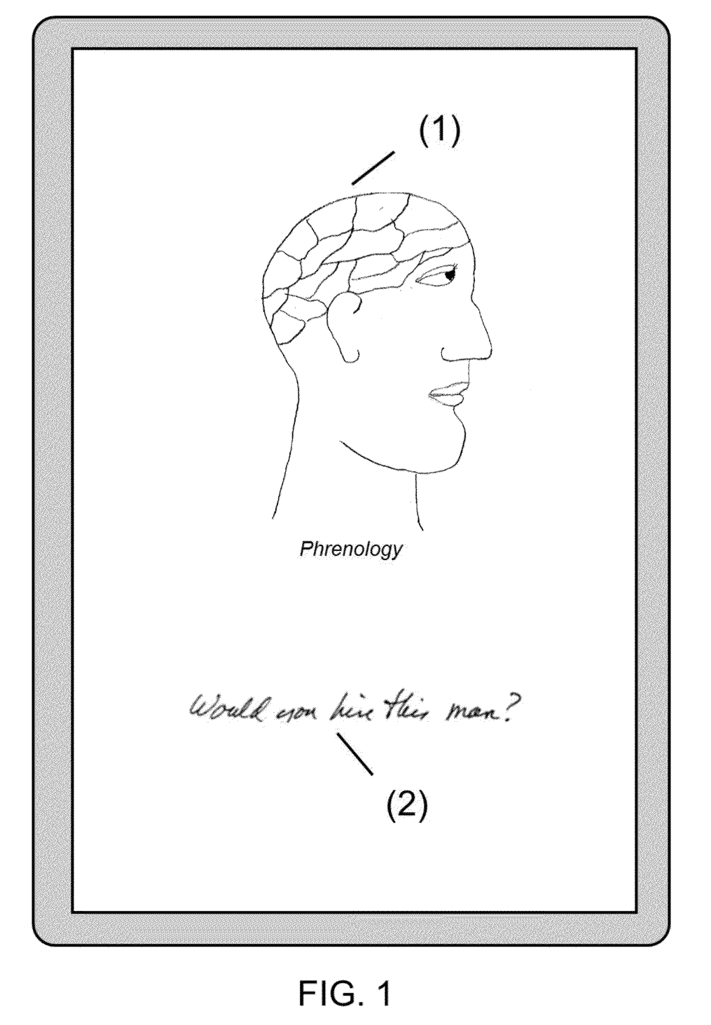

The instant invention provides an apparatus and method for integrating a subset of information from various sources that can be linked back to the source. FIG. 1 depicts a portion of the integrated summary document that has a particular FIG. 1) from an electronic textbook included. The FIG. 1) is included in the integrated summary document, in response to a user selection of the FIG. 1) from the electronic textbook. The user selection can be achieved by a touch gesture on the content if the content is displayed on a touch sensitive device. Alternatively, the user selection can be done through highlighting or a variety of other user inputs. Within the integrated summary document, the FIG. 1) is electronically linked to the electronic textbook that contains the FIG. 1). The integrated summary document can also contain user inserted notes (2) related to the FIG. 1).

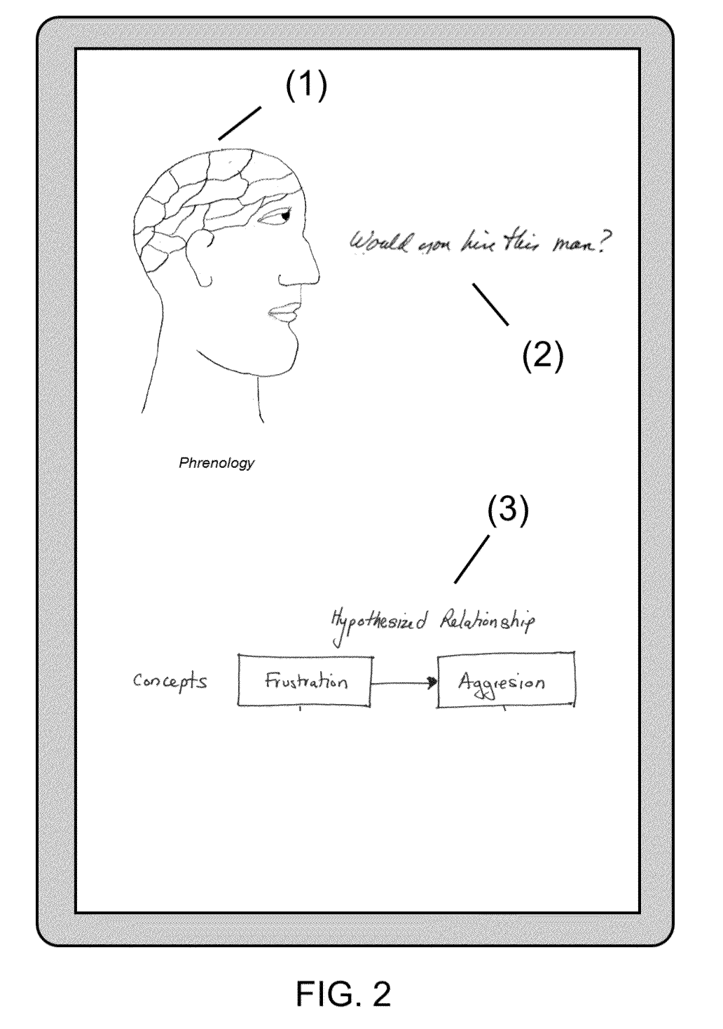

FIG. 2 depicts another portion of the same integrated summary document that has an image (3) that was generated during a help session with a teaching assistant for the class. The image can be linked, for example, to a collection of other material generated during the help session. User inserted highlights or notes can also accompany the image within the integrated summary document. The image (3) is included in the integrated summary document, in response to a user selection of the image (3).

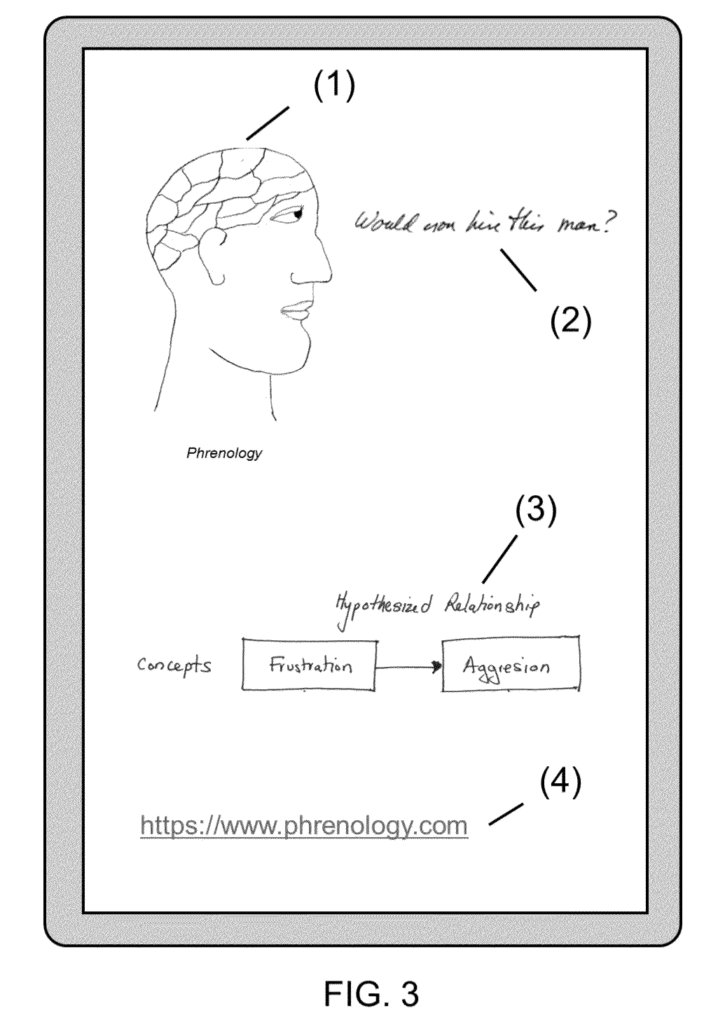

FIG. 3 depicts yet another portion of the same integrated summary document that has a social learning element (4) included in the integrated summary document. In this case the social learning element is a question and answer session on a specific portion of a course textbook.

The integrated summary document synthesizes many different sources of information that are all related by a common theme such as a particular student course. The integrated summary document can have selected portions of different textbooks with links to those textbooks as well as user inserted notes and links to searches and other social learning elements. This integrated summary document helps organize and prioritize information.

The integrated summary document can also be used to store multimedia elements alongside the content from the book. A user can take a picture of a whiteboard, their own notes or notes from a study partner and include it in the integrated summary document. A user can also record audio and video notes for inclusion in the integrated summary document. In addition, the integrated summary document can be shared with others to make learning more social.

In the claims:

1. A computer readable medium capable of storing a program facilitating the following steps:
receiving user inputs selecting portions of multiple electronic documents;
copying the selected portions of said multiple electronic documents into separate document; and,
displaying in said separate document location information for said selected portions of multiple
electronic documents corresponding to the location in the said multiple electronic documents.

2. The computer readable medium of claim one capable of storing a program facilitating the following additional step:
linking the selected portions of said multiple electronic documents in said separate document to the original multiple electronic documents.

3. The computer readable medium of claim one capable of storing a program facilitating the following additional step:
initiating a search based on a received input;
displaying the results or a summary of results of said search in said separate document.

4. The computer readable medium of claim three capable of storing a program facilitating the following additional step:
linking said results or summary of results in said separate document to the original source of the results.

5. The computer readable medium of claim two capable of storing a program facilitating the following additional step:
linking social media sites to said separate document.

6. The computer readable medium of claim three capable of storing a program facilitating the following additional steps:
receiving input selecting additional media content; and
displaying selected media content within said separate electronic document.

7. A method for generating an electronic document comprising the steps of:
receiving user inputs selecting portions of multiple electronic documents;
copying the selected portions of said multiple electronic documents into separate document; and,
displaying in said separate document location information for said selected portions of multiple electronic documents corresponding to the location in the said multiple electronic documents.

8. The method of claim seven comprising the following additional step:
linking the selected portions of said multiple electronic documents in said separate document to the original multiple electronic documents.

9. The method of claim seven capable of storing a program facilitating the following additional step:
initiating a search based on a received input;
displaying the results or a summary of results of said search in said separate document.

10. The method of claim nine capable of storing a program facilitating the following additional step:
linking said results or summary of results in said separate document to the original source of the results.

11. The method of claim eight capable of storing a program facilitating the following additional step:
linking social media sites to said separate document.

12. The method of claim seven capable of storing a program facilitating the following additional steps:
receiving input selecting additional media content;
displaying selected media content within said separate electronic document.
